(19) United States
(12) Patent Application Publication
(10) Pub. No.: US 2026/0326960 A1
(43) Pub. Date: Oct. 22, 2026

(54) A LABELLING MACHINE AND CARRIER

(71) Applicant: Dover Europe Sàrl, Vernier (SE)

(72) Inventor: Jonas Södergård, Vastra Frolunda (SE)

(21) Appl. No.: 19/100,495

(22) PCT Filed: Aug. 1, 2023
(86) PCT No.: PCT/EP2023/071343

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 1/02; B65C 9/40

(52) U.S. Cl. CPC B65C 1/021; B65C 9/40

(57) ABSTRACT

The specification discloses a labelling machine comprising: a label applicator arrangement; a support structure; a lifting mechanism. The lifting mechanism comprises: a drive system comprising a drive shaft, belts operably connected to the drive shaft and configured to vertically displace the label applicator arrangement along the support structure; a counterweight mechanically connected to one end of said belts; tensioners associated with each belt.

### TECHNICAL FIELD

The disclosure relates generally to a labelling machine and in particular aspects, the disclosure relates to a labelling machine for applying labels in vertical direction on an object and a carrier or lifting arrangement. The arrangement of the disclosure can cooperate with an industrial printer in general and label printers, in particular.

### BACKGROUND

A labelling machine is utilized for applying labels to packaging or products. Some known labelling machines comprise a label dispenser that supplies pre-printed labels from a source and an applicator that applies the pre-printed labels to an article. Other known labelling machines may print information onto labels immediately before printed labels are applied to an article. Such labelling machines may be referred to as print and apply (P&A) labelling machines. In some other known labelling machines, an over-printing function may be used that over-prints parts of a label before application of the label. In many production sites, products are packaged and provided on pallets. The height of the packages on the pallets may vary. When labelling products on pallets especially automated labelling a challenge is accessing different positions on the package, especially vertically, which requires a lifting arrangement. Many lifting arrangements operate using compressed air. Currently there is a growing focus on sustainability, leading to a demand for compressed air-free solutions. The design of lifts without compressed air is important for several reasons, including:
Energy Efficiency: Compressed air systems can consume a significant amount of energy, resulting in higher operational costs. By eliminating the need for compressed air in lift design, energy consumption can be reduced, leading to increased energy efficiency and cost savings.
Environmental Impact: Compressed air generation often requires the use of energy sources that contribute to environmental pollution, such as fossil fuels. Minimizing or eliminating the reliance on compressed air in lift designs helps reduce carbon emissions and contributes to a greener and more sustainable environment.
Maintenance and Reliability: Compressed air systems involve complex components, such as compressors, filters, and valves, which require regular maintenance and servicing. Designing lifts without compressed air simplifies the system, reducing the number of components that can fail or require maintenance. This can enhance the reliability and uptime of the lift, minimizing downtime and maintenance costs.
Safety: Compressed air systems present potential safety risks, such as leaks, ruptures, or sudden pressure releases. By eliminating or reducing the use of compressed air in lift designs, the associated safety hazards can be mitigated, creating a safer working environment for operators and users.
Simplified Design and Installation: Lift designs without compressed air can be simpler and more streamlined. They often involve fewer components, simpler control systems, and easier installation processes. This simplification can result in faster installation times, reduced complexity during construction or retrofitting, and improved overall system performance.
Noise Reduction: Compressed air systems can generate noise due to the operation of compressors, valves, and other pneumatic components. By eliminating or reducing the reliance on compressed air, lift designs can contribute to a quieter and more comfortable environment for users and nearby occupants.

In summary, the design of lifts without compressed air offers benefits in terms of energy efficiency, environmental sustainability, maintenance and reliability, safety, simplified design and installation, and noise reduction. These advantages make such lift designs more cost-effective, environmentally friendly, and user-friendly, contributing to improved overall lift performance.

To overcome these challenges, employing proper labelling techniques and automation solutions can help improve the efficiency and accuracy of product labelling on pallets. Consequently, one challenge is to design a lifting device that is save, fast, consumes a minimum of power, doesn't use compressed air and is compact.

### SUMMARY

The disclosed labelling and lifting arrangement provide solutions for previously mentioned challenges and provides a reliable, quick lifting device, which also can operate with a motor ensuring low and safe forces, low cost and low power consumption can be used.

According a first aspect, labelling machine is provided, comprising: a label applicator arrangement; a support structure; a lifting mechanism, the lifting mechanism comprising: a drive system comprising a drive shaft, at least two belts operably connected to the drive shaft and configured to substantially vertically displacing the label applicator arrangement along the support structure; a counterweight mechanically connected to one end of said at least two belts; and at least two tensioners associated with each belt.

According to a second aspect, a controller for controlling operation of the labelling machine according to the first aspect is provided.

According to a third aspect, a print and apply system is provided comprising a labelling machine according to the first aspect and a label printer.

According to a fourth aspect, an arm assembly is disclosed comprising: a support structure; a lifting mechanism. The lifting mechanism comprising: a drive system comprising a drive shaft, at least two belts operably connected to the drive shaft and configured to substantially vertically displacing an object along the support structure; a counterweight mechanically connected to one end of said at least two belts; and at least two tensioners associated with each belt. The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples. Reference is made to the attached drawings, wherein elements having the same reference number designation may represent like elements throughout.

FIGS. 1a and 1b depict schematically views of a print and apply system comprising a lifting device according to the present disclosure;

FIG. 2 is a cross-sectional view of a portion of the lifting device in FIG. 1a or 1b;

FIG. 3 is a view along line A-A in FIG. 2; and

FIG. 4 is a block diagram of an exemplary controller used in a device according to present disclosure.

### DETAILED DESCRIPTION

In the following disclosure a lifting and supporting device is described with reference to labelling and print and label applications. However, to a person skilled in the art, it is evident that the device has the potential for application in numerous other applications.

The term “industrial printer”, also known as an “industrial-grade printer”, as used herein, may refer to a type of printer specifically designed for heavy-duty printing tasks in industrial environments. These types of printers are built to handle large volumes of printing, often with high-speed and precision, and are capable of printing on various materials such as paper, cardboard, labels, plastics, and metals. The industrial printers, as referred to herein, may commonly be used in sectors like manufacturing, logistics, packaging, and retail, where there is a need for efficient and reliable printing solutions. They are typically more robust and durable compared to standard office printers, as they are required to withstand harsher conditions and extended operation periods.

Depending on the specific application, industrial label printers may utilize different printing technologies. Some common types may include:
Thermal Transfer Printers (TTP): These printers use heat to transfer ink from a ribbon onto the printing material, such as labels or tags. They are widely used for barcode printing and labeling applications.
Direct Thermal Printers (DTP): These printers use heat-sensitive paper that turns black when exposed to heat, creating the desired print. They are commonly used for printing receipts, shipping labels, or temporary labels.
Inkjet Printers: Industrial inkjet printers use inkjet technology to propel tiny droplets of ink onto the printing surface. They can print high-resolution images and are suitable for printing on various materials, including paper, plastics, and metals.
Laser Printers: Industrial laser printers use laser technology to create the desired print. They are often used for high-speed and high-volume printing applications, such as printing documents or product packaging.
Thermal Transfer Overprinter (TTO Printer): TTO printers use a thermal transfer printing method. The printer has a thermal printhead, which contains an array of tiny heating elements. When the printhead comes into contact with the thermal transfer ribbon (also known as TTR or ink ribbon) and the packaging material, it selectively heats the ribbon to transfer ink onto the substrate, creating the desired print.

Industrial printers may also incorporate additional features, such as advanced connectivity options, rugged enclosures, automatic label applicators, or integrated systems for data management and control. These features enhance their productivity, efficiency, and integration with other industrial processes.

The term “label”, as used herein, may include an information carrier media which can be made of several types of materials, depending on the specific requirements and application. Some common materials used for printer labels may for example include (but not limited to): paper, synthetic materials, cardstock, clear and transparent materials, thermal labels, and specialty materials.

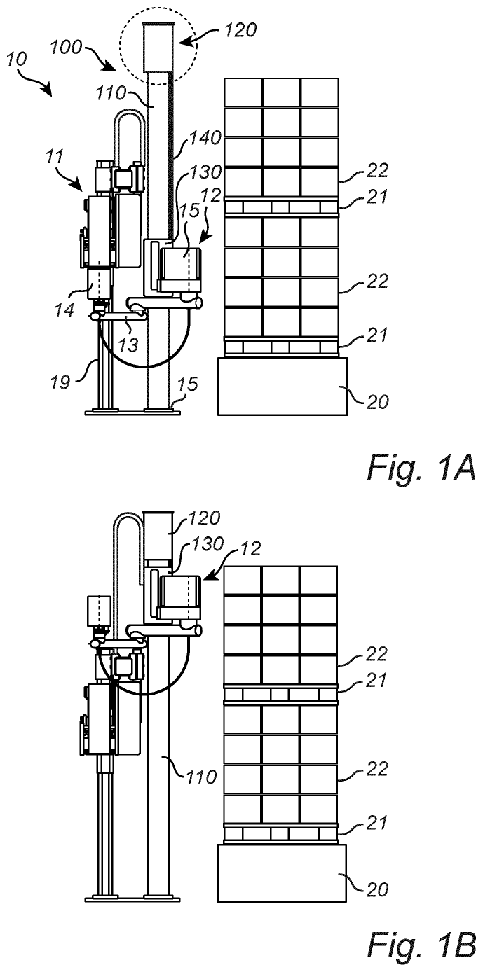

FIGS. 1a and 1b are schematic views of a labelling system 10 comprising a lifting device 100 according to the present disclosure, in an exemplary production site. A pallet conveyor 20, transports pallets 21 loaded with goods 22 past the marking station. In this case, pallets are stacked on top of each other.

The system 10 may comprise an industrial label printer 11 in case of a print and apply system or a label dispenser (11) and a label applicator 12, such as a label applicator system as disclosed in the parallel application with title “A LABEL APPLICATOR ARRANGEMENT AND METHOD”, Application No. PCT/EP2023/071289, incorporated herein through reference.

The lifting device 100 comprises a substantially tubular support structure or column 110, a drive housing 120 an external carrier 130, and at least one carrier belt 140. According to this example, the column 110 is fixed to the floor of, e.g., a production site, by means of an end beam 15. However, the lifting device may also be arranged mobile, for example on a mobile platform of an AGV, etc.

In this example, the label printer 11 is arranged on a separate support structure 19 and is stationary while the applicator main body 12 is arranged on the external carrier of the lifting device 100. In operation, the label printer 11 prints a label upon reception of print signal from a controller (not shown in FIGS. 1a-1b). The label applicator 12 receives a label application signal and moves to a label receiver position from the label printer 11 by its applicator arm 13 provided with an application pad 14 and receives a label. If the application position is in the correct vertical position, it swings the arm and applies the label on the item in correct position on the pallet. If the application position is higher or lower, the lifting device 100 receives a signal from a controller to relocate the applicator and relocates the applicator to a correct vertical position to apply the label, as shown in FIG. 1b. The lifting device may relocate the applicator to the same height as the printer and label receiving position to receive a new label.

In some exemplary embodiments, the printer may also be arranged on same lifting device as the applicator or a separate lifting device.

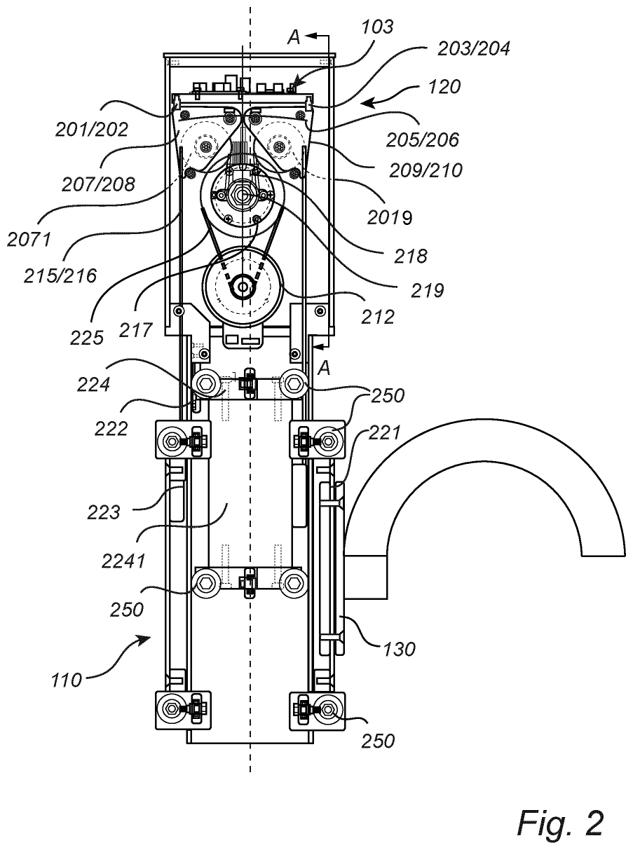

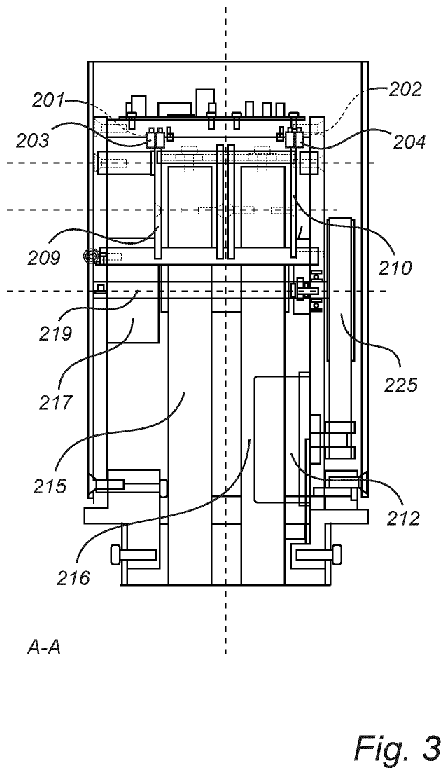

FIG. 2 illustrates schematically the enlarged encircled portion of FIG. 1 showing a cross sectional view of the drive housing 120 and parts of the column 110. FIG. 3 is a cross-sectional view along line A-A in FIG. 2. The lifting device 100 comprises internally: sensors 201-204 (sensors 202 and 204 not visible in FIG. 2), at least two springs 205/206 (spring 206 at the back side not shown), first tensioners 207 (tensioner 208 at the back side of the Fig. not shown), tensioner on the second side 209 (tensioner 210 at the back side not shown), a system controller 103, a motor 212, at least two redundant belts 215 and 216, a brake 217, a pulse encoder 218, a main drive shaft 219, a calibration sensor 222, a magnet 223, an internal carrier 224, a counter weight 2241, and a transmission belt 225. The driver belts 215 and 216 may comprise any other driver means such as chains etc. In FIG. 2, each belt has a path running around the drive shaft (that can be said is underside of the shaft in the drawing) continuing to the pullies or bearings 2071 and 2091 of the tensioners at left-and right-hand side of the drive shaft 219 before the belt connects to the lifting carriers 130 and 224. The tensioners may have stopping means to restrict bearings movement.

Here, the first and second tensioners refer to the direction of the belt towards or out from the drive shaft when drive shaft rotates and may change.

The internal carrier 224 comprise the counterweight 2241 that balances the system. At least two redundant belts 215 and 216 connect the internal and external carriers, 224 and 130. The counterweight 2241 maintains the tension in the belts 215 and 216. The motor 212 is connected to a main drive shaft 219 driving both belts. As mentioned, every belt 215/216 comprises one tensioner 207/208 on the first side of the main drive shaft 219 and one tensioner on the second side 209/210 of the main drive shaft. If both belts 215 and 216 are equally adjusted, then all tensioners are kept in their fully compressed position during normal operation. If there is a slight difference in belt adjustments, then the tensioners will keep tension in the lesser tightened belt. Two springs 205 and 206 are provided to keep tension in the tensioners.

All four tensioners may have a corresponding sensor 201, 202, 203 and 204, detecting when each corresponding tensioner reaches its fully decompressed position. This may only occur during the startup checking procedure and at belt brakeage.

Generally, a tensioner's main function is to counteract the natural slackening or elongation that can occur in belts, chains, or other flexible elements over time due to wear, temperature variations, or other factors. By applying and maintaining the correct tension, the tensioner ensures proper operation, preventing slip, excessive vibration, or premature wear in the system. In some exemplary embodiments spring tensioners may be utilized. A brake 217 is arranged to engage on the main drive shaft 219 at power off or failure, and thereby holds the external carrier 130 in place when the lifting device is shut off. In one embodiment, a signal upon for example failure can be transmitted to the production line to stop the line to prevent product damage, operator/human risk, etc.

The motor 219 drives the main drive shaft through a transmission belt 225 (or other transmission arrangement) that reduces the gearing.

The system controller 103 continuously compares the motor drive movement to the resulting read out from the pulse encoder 218 on the main drive shaft 219. If there at any time is a significant deviation, the brake is activated and lock lifting device is locked/disabled. An alternative solution could be to use a distance sensor to check that the internal carrier is moving according to the motor movement.

A number of wheels, bearings or casters 250 may be provided on the internal, external and counterweight to support and/or facilitate mobility and manoeuvrability of the parts.

Due to the counterweight, selected to reasonable counterweight to the load, the lifting device can operate with a motor/actuator ensuring low and safe forces, low cost and low power consumption can be used.

The calibration sensor 222, e.g., of hall type or any other sensor which detects the presence and magnitude of a magnetic field, detects when the external carrier is close to its upper position. A magnet 223 is therefore placed in the external carrier for this purpose. The sensor is used during the startup procedure to make sure that, for example, belt wear doesn't affect the positioning of the external carrier. Of course, other detection methods such distance measuring, laser sensors or similar, can be used.

All sensors provided the system controller with sensor data and the motor as well as the brake are controlled by the system controller.

A safety checking procedure can be executed at every startup, for example comprising the following steps:
1. Check the brake and the transmission. Activate the brake and run the motor. Make sure the carriers and belts are not moving by for example checking that no corresponding angle change is detected on the main drive shaft. If the motor and main drive shaft are moving, then the brake is faulty. If the motor is moving but not the main drive shaft, then the transmission is faulty/the transmission belt is broken. When a motor is connected directly to the main drive shaft then it is enough to make sure the motor drive shaft is not responding to the motor activation to make sure the brake is working.
2. Check the second tensioner sensors 203 and 204. Run the external carrier up until the internal carrier, with the counterweight, reaches its bottom position. Make sure that sensors 203 and 204 both transition from deactivated to activated by too low belt tension. During this operation the calibration sensor is checked and the system uses this as the reference point for the external carrier position. The sensor is placed so that it is supposed to be passed by the external carrier near the top. If this doesn't happen, either the belts are too long, or the calibration sensor is faulty. However, the external carrier shall also not pass the calibration sensor by too much, because this would indicate that the belts are too short. When the belts are too short the external carrier will reach its upper stop position, which will prevent the internal carrier from reaching its bottom position and this safety check point will fail. In this step the pulse encoder is checked. If any of the sensors 203 and 204 or the calibration sensor 222 are transitioning without pulses coming from the pulse encoder, this means that the pulse encoder is faulty. In summary this step will make sure that sensor 203 and 204, and the pulse encoder works, check that the belts have the right length, check that the calibration sensor works and set position reference for the external carrier.
3. Check the outgoing tensioner sensors 201 and 202. Run the external carrier to its bottom position and make sure sensors 201 and 202 transit from deactivated to activated state by too low belt tension.
4. Calibrate expected applied motor force. Record the current usage during the complete process to receive a baseline for what is an expected resistance. Use this to detect blockages during normal operation.

As mentioned previously, the operation of the lifting device is controlled by a controller, including controlling the driving motor, receiving sensorial or encoder signals from various sensors or communicate with for example, the printer and the applicator device. The controller may be stand alone or part of the site controller.

A user interface may also be provided in communication with the controller allowing for configuration settings, adjustment of speed, and monitoring of the lifting operation.

For these purposes a sensor system may be included in the lift device and/or in case of print and apply or only label application as disclosed, comprising optical sensors, proximity sensors, or combination thereof, providing accurate detection of the object's presence and positioning for efficient label application.

In some exemplary embodiments, a lock or pin for service in the upper position may be provided to allow the applicator to be removed thus destabilizing the balance, the pin/lock may allow an operator to work low down reducing the lift and, e.g., avoiding injury as a result.

In some exemplary embodiments two or more drive shafts may be used to operate the belts.

In some exemplary embodiments, the lifting device may be adopted to carry/lift one or more of marking device, printers (e.g., laser, inkjet) or any other operational devices.

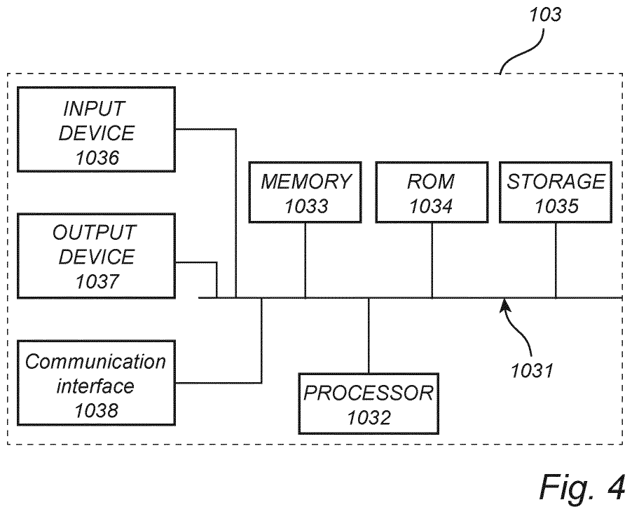

FIG. 4 illustrates schematically an exemplary controller 103. The controller 103 may communicate with various sensors of the printer, such as the encoder for motors 132, 152, 162, and 170. The controller may be stand alone or be part of the printer controller as mentioned previously. The controller 103 as described earlier in which methods and systems described herein may be implemented, may include a bus 1310, a processor 1032, a memory 1033, a read only memory (ROM) 1034, a storage device 1350, an input device 1035, an output device 1037, and a communication interface 1038. The bus 1031 permits communication among the components of controller 103. The bus may be any of several types of bus structures that may further interconnect to a memory bus (with or without a memory controller), a peripheral bus, and/or a local bus using any of a variety of bus architectures. The controller 103 may also include one or more power supplies (not shown). One skilled in the art would recognize that controller 103 may be configured in several other ways and may include other or different elements.

The processor 1032 may include any type of processor or microprocessor that interprets and executes instructions. The processor 1032 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor may further include computer executable code that controls operation of the programmable device. The processor 1032 may also include logic that is able to receive and compile instructions and interpret different signal, and also generate output to, for example, a speaker, a display, etc.

The memory 1033 may include a random-access memory (RAM) or another dynamic storage device that stores information and instructions for execution by processor 1032. Memory 1033 may also be used to store temporary variables or other intermediate information during execution of instructions by processor 1032. The memory 1033 may be one or more devices for storing data and/or computer code for completing or facilitating methods described herein. The memory may include database components, object code components, script components, or other types of information structure for supporting the various activities herein. Any distributed or local memory device may be utilized with the systems and methods of this description. The memory may be communicably connected to the processor device (e.g., via a circuit or any other wired, wireless, or network connection) and may include computer code for executing one or more processes described herein. The memory may include non-volatile memory 1034 (e.g., read-only memory (ROM), erasable programmable read-only memory (EPROM), electrically erasable programmable read-only memory (EEPROM), etc.), and volatile memory (e.g., random-access memory (RAM)), or any other medium which can be used to carry or store desired program code in the form of machine-executable instructions or data structures and which can be accessed by a computer or other machine with a processor. A basic input/output system (BIOS) may be stored in the non-volatile memory 1034 and can include the basic routines that help to transfer information between elements within the controller.

ROM 1034 may include a conventional ROM device and/or another static storage device that stores static information and instructions for processor 1032. Storage device 1350 may include a magnetic disk or optical disk and its corresponding drive and/or some other type of magnetic or optical recording medium and its corresponding drive for storing information and instructions. Storage device 1350 may also include a flash memory (e.g., an electrically erasable programmable read only memory (EEPROM)) device for storing information and instructions.

Input device 1035 may include one or more conventional mechanisms that permit a user to input information to the controller 103, such as a keyboard, a keypad, a directional pad, a mouse, a pen, voice recognition, a touch-screen and/or biometric mechanisms, etc. Output device 1037 may include one or more conventional mechanisms that output information to the user, including a display, a printer, one or more speakers, etc. Communication interface 1038 may include any transceiver-like mechanism that enables controller 103 to communicate with other devices and/or systems. For example, communication interface 1038 may include a modem or an Ethernet interface to a LAN. Alternatively, or additionally, communication interface 1038 may include other mechanisms for communicating via a network, such as a wireless network. For example, communication interface may include a radio frequency (RF) transmitter and receiver and one or more antennas for transmitting and receiving RF data.

The controller 103, consistent with the disclosure, provides a platform through which the various functions of applicator stand alone or in combination with a printer are controlled. The controller 103 may also display information associated with the label application status of printer relevant information.

According to an exemplary implementation, controller 103 may perform various processes in response to processor 1032 executing sequences of instructions contained in memory 1033. Such instructions may be read into memory 1033 from another computer-readable medium, such as storage device 1350, or from a separate device via communication interface 1038. It should be understood that a computer-readable medium may include one or more memory devices or carrier waves. Execution of the sequences of instructions contained in memory 1033 causes processor 1032 to perform the acts that have been described. In alternative embodiments, hard-wired circuitry may be used in place of or in combination with software instructions to implement aspects consistent with the disclosure. Thus, the disclosure is not limited to any specific combination of hardware circuitry and software.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the disclosure may be implemented at least in part by means of both hardware and software, and that several “means”, “units” or “devices” may be represented by the same item of hardware.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Software and web implementations of various embodiments of the disclosed methods can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A labelling machine comprising:
a label applicator arrangement;
a support structure;
a lifting mechanism, the lifting mechanism comprising:
a drive system comprising a drive shaft,
belts operably connected to the drive shaft and configured to vertically displace the label applicator arrangement along the support structure;
a counterweight mechanically connected to one end of said belts; and
tensioners associated with each belt.

2. The labelling machine of claim 1, wherein one tensioner is arranged on a first side of the drive shaft and one tensioner on a second side of the drive shaft for each belt.

3. The labelling machine of claim 1, wherein the tensioners are configured to equally adjust each belt such that all of the tensioners are kept in a fully compressed position during normal operation.

4. The labelling machine of claim 3, wherein the tensioners are configured to, in case of a difference in belt adjustment between the belts, maintain tension in a lesser tightened belt.

5. The labelling machine of claim 1, further comprising a sensor associated with each tensioner.

6. The labelling machine according to claim 1, further comprising a brake configured to engage on the drive shaft.

7. The labelling machine according to claim 1, wherein the drive system further comprises an actuator configured to rotationally drive the drive shaft.

8. The labelling machine according to claim 1, further comprising a sensor configured to detect when a carrier carrying the label applicator arrangement is close to its upper position.

9. The labelling machine according to claim 8, wherein the sensor is configured to detect presence and magnitude of a magnetic field.

10. The labelling machine according to claim 1, including a controller for controlling operation of the labelling machine.

11. The labelling machine of claim 10, wherein the controller is configured to continuously compare an actuator drive movement to a resulting read out from a pulse encoder on the drive shaft and in case of a significant deviation, to activate a brake.

12. A print and apply system comprising a labelling machine and a label printer, the labelling machine comprising:
a label applicator arrangement;
a support structure;
a lifting mechanism, the lifting mechanism comprising:
a drive system comprising a drive shaft,
belts operably connected to the drive shaft and configured to vertically displace the label applicator arrangement along the support structure;
a counterweight mechanically connected to one end of said belts; and
tensioners associated with each belt.

13. A lifting assembly comprising:
a support structure;
a lifting mechanism, comprising:
a drive system comprising a drive shaft,
belts operably connected to the drive shaft and configured to vertically displace an object along the support structure;
a counterweight mechanically connected to one end of said belts; and
tensioners associated with each belt.

14. The lifting assembly of claim 13, wherein one tensioner is arranged on a first side of the drive shaft and one tensioner on a second side of the drive shaft for each belt.

15. The lifting assembly of claim 14, wherein the tensioners are configured to equally adjust each belt such that all of the tensioners are kept in a fully compressed position during normal operation.

16. The lifting assembly of claim 15, wherein the tensioners are configured to, in case of a difference in belt adjustment between the belts, maintain tension in a lesser tightened belt.

17. The lifting assembly of claim 16, further comprising a sensor associated with each tensioner.

18. The lifting assembly of claim 16, further comprising a brake configured to engage on the drive shaft.

19. The lifting assembly of claim 16, wherein the drive system further comprises an actuator configured to rotationally drive the drive shaft.

20. The lifting assembly of claim 16, further comprising a sensor configured to detect when a carrier carrying the object is close to its upper position.
